(19) United States
(12) Patent Application Publication
(10) Pub. No.: US 2011/0031061 A1
(43) Pub. Date: Feb. 10, 2011

(54) Electroacoustic Transducer

(75) Inventors: Jens Wildhagen, Burgdorf (DE); Jan Peter Kuhtz, Celle (DE); Axel Grell, Burgdorf (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sennheiser Electronic GmbH & Co. KG, Burgdorf (DE)

(21) Appl. No.: 12/518,078

(22) PCT Filed: Dec. 10, 2007
(86) PCT No.: PCT/EP07/63602

§ 371 Date: Oct. 26, 2010

(30) Foreign Application Priority Data
Dec. 8, 2006 (DE) 10 2006 058369.8

(51) Int. Cl. H04R 7/14

(52) U.S. Cl. 181/173

(57) ABSTRACT

Provided is an electroacoustic transducer having a diaphragm (10). The diaphragm (10) has a first and a second region (20, 30), wherein the hardness, stiffness or compliance of the first region (20) differs from the second region (30).

The present invention concerns an electroacoustic transducer and a diaphragm for an electroacoustic transducer.

Diaphragms for electroacoustic transducers can involve different levels of stiffness, in which respect usually different materials involving different levels of stiffness are assembled to produce a corresponding diaphragm.

In the case of such diaphragms however it is found to be disadvantageous as both eigenmodes and also resonances occur.

Assembling different materials to obtain a corresponding diaphragm represents a costly solution as well as a relatively complicated and expensive production procedure.

DE 103 28 380 A1 discloses a sound transducer with a sealed rear volume chamber which is small in relation to the transducer. The relationship between the diaphragm mass and the rear volume is so selected that the spring stiffness of the diaphragm restraint arrangement is selected to be so low that it is significantly below the spring stiffness of the enclosed rear volume.

Therefore the object of the present invention is to provide an electroacoustic transducer having a diaphragm with a variable stiffness, strength or compliance.

That object is attained by an electroacoustic transducer as set forth in claim 1.

Thus there is provided an electroacoustic transducer having a diaphragm. The diaphragm has first and second regions, wherein the hardness, stiffness (rigidity) or compliance of the first region differs from the first region.

The invention is based on the notion of providing a diaphragm having soft or pliant corrugations and a hardened spherical cup portion. The diaphragm thus has different levels of hardness or stiffness in different regions. Preferably at least a part of the diaphragm is hardened or stiffened for example by beam-crosslinking.

Thus it is possible to obtain a diaphragm having a low resonance frequency and very good high radiation, wherein the diaphragm is made from a single material.

Further aspects of the invention are subject-matter of the appendant claims.

The advantages and embodiments by way of example of the present invention are described in greater detail hereinafter with reference to the drawing.

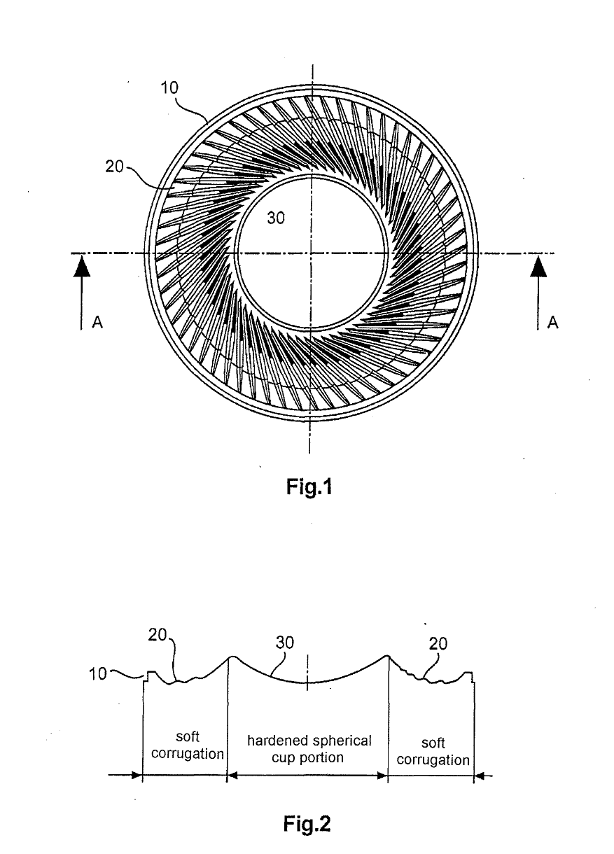

FIG. 1 shows a diagrammatic plan view of a diaphragm in accordance with a first embodiment, and

FIG. 2 shows a sectional view of the diaphragm of FIG. 1.

FIG. 1 shows a diagrammatic plan view of a diaphragm in accordance with a first embodiment. In this case the diaphragm 10 has a corrugation 20 and a spherical cup portion 30.

FIG. 2 shows a sectional view along line A-A of the diaphragm of FIG. 2. The diaphragm thus has two corrugation portions 20 and a spherical cup portion 30. Preferably the corrugations are of a soft or pliant nature while the spherical cup portion has been hardened or stiffened, that is to say the spherical cup portion is of higher stiffness than the corrugation portions. In addition the diaphragm can be produced from one material or in one piece, in which case the spherical cup region 30 can be subsequently hardened or stiffened. That subsequent hardening or stiffening can be effected for example by beam-crosslinking, in which case hardening or stiffening can be effected by an interlinkage of plastic material molecules. In that situation the corrugation regions 20 are not hardened or stiffened so that they are soft or are of a low level of stiffness. As already described hereinbefore the diaphragm is preferably made from a homogeneous material and optionally subsequently treated. Preferably in that case no further material is applied, in the sense of a coating, a dye or a lacquer. Rather the diaphragm is subjected to a treatment in which the properties of the material of the diaphragm are altered (hardened).

A reduction in eigenmodes can be achieved by the partially hardened or stiffened diaphragm. A low resonance frequency can also be made possible.

Furthermore the stiffness (compliance) of the corrugation can be reduced (increased) in the transitional region between the corrugation and the spherical cup portion. Alternatively the stiffness of the corrugation can decrease towards the edge regions. The spherical cup portion can also be at least partially (subsequently) hardened or stiffened.

The above-described electroacoustic transducer can be used in an electronic device such as for example a microphone, a cellular telephone, a loudspeaker or the like.

1. An electroacoustic transducer comprising
a diaphragm which has at least a first and a second region, wherein the stiffness of the first region differs from the stiffness of the second region;
wherein the diaphragm is produced from a one-piece material.

2. An electroacoustic transducer as set forth in claim 1 wherein the first region represents a corrugation and the second region represents a spherical cup portion.

3. (canceled)

4. An electroacoustic transducer as set forth in claim 1 wherein the region of the spherical cup portion is subsequently at least partially stiffened.

5. An electroacoustic transducer as set forth in claim 1 wherein the stiffness of the corrugation and/or spherical cup portion decreases or the compliance of the corrugation and/or spherical cup portion increases in the transitional region between the corrugation and the spherical cup portion.

6. An electroacoustic transducer as set forth in claim 1 wherein the diaphragm is of a one-piece configuration.

7. A diaphragm for an electroacoustic transducer comprising a corrugation and a spherical cup portion wherein the corrugation and the spherical cup portion are of different levels of stiffness.

8. An electroacoustic device having an electroacoustic transducer as set forth in claim 1.
